(19) United States
(12) Patent Application Publication
(10) Pub. No.: US 2019/0152351 A1
(43) Pub. Date: May 23, 2019

(54) VEHICLE SEAT DEVICE

(71) Applicant: SHIROKI CORPORATION, Fujisawa-shi (JP)

(72) Inventors: Yuta Murakami, Nagoya-shi (JP); Toshiaki Nagata, Aichi-ken (JP)

(73) Assignee: SHIROKI CORPORATION, Fujisawa-shi (JP)

(21) Appl. No.: 16/183,109

(22) Filed: Nov. 7, 2018

(30) Foreign Application Priority Data
Nov. 17, 2017 (JP) 2017-222050

(51) Int. Cl. B60N 2/16; B60N 2/02

(52) U.S. Cl. CPC B60N 2/161; A47C 3/20; B60N 2002/0236; B60N 2/0232

(57) ABSTRACT

A vehicle seat device lifts and lowers a seat. The vehicle seat device includes a base, a lifter link, and a drive device. The lifter link includes a plurality of members that move a seat cushion of the seat vertically relative to the base. The drive device is coupled to the lifter link. The drive device relatively moves the lifter link. The drive device is attached to the base, a vehicle floor, or a seat-mounting device fixed to the vehicle floor.

### BACKGROUND

The present invention relates to a vehicle seat device that lifts and lowers a seat.

Japanese Laid-Open Patent Publication No. 2017-65550 describes a technique for a vehicle seat device that lifts and lowers a seat of a vehicle. The vehicle seat device of the document may include a link mechanism provided in the front of the seat and a link mechanism provided in the rear of the seat. The mechanism in the front of the seat may be moved by a drive device attached to the seat cushion.

### SUMMARY

terms of energy conservation, it is desired that the link mechanism be driven with less power consumption. In this regard, there is still room for improvement in the vehicle seat device of Japanese Laid-Open Patent Publication No. 2017-65550. It is an object of the present description to provide a vehicle seat device that is driven with less power consumption.

A vehicle seat device that solves the above problem lifts and lowers a seat. The vehicle seat device includes a base, a lifter link, and a drive device. The lifter link includes a plurality of members that move a seat cushion of the seat vertically relative to the base. The drive device is coupled to the lifter link. The drive device relatively moves the lifter link. The drive device is attached to the base, a vehicle floor, or a seat-mounting device fixed to the vehicle floor.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferable embodiments together with the accompanying drawings in which:

FIG. 1 is a side view showing a seat;

FIG. 2 is an exploded view showing a front lift mechanism;

FIG. 3 is a side view showing a vehicle seat device in the middle of a first movement;

FIG. 4 is a side view showing the vehicle seat device when the first movement is completed; and

FIG. 5 is a side view showing the vehicle seat device when a second movement is completed.

### DETAILED DESCRIPTION

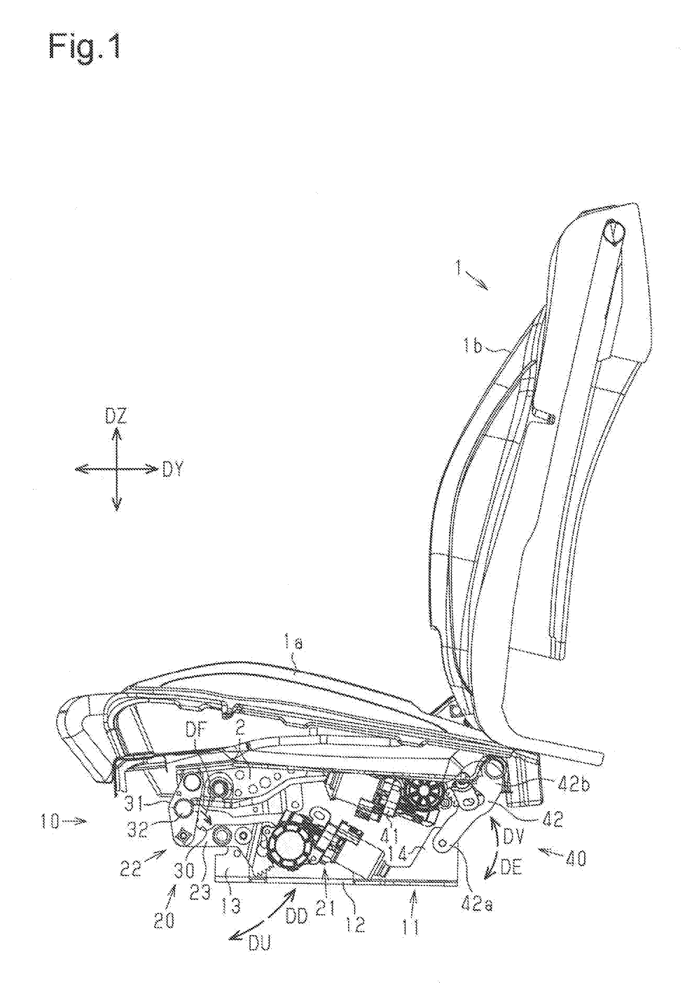

A vehicle seat device will now be described with reference to FIGS. 1 to 5.

The position of a vehicle seat device 10 when attached to the vehicle in a state of facing the front side is hereinafter referred to as a reference position of the vehicle seat device 10. In the following description of each component of the vehicle seat device 10, it is assumed that the vehicle seat device 10 is located in the reference position. More specifically, a vehicle width direction DX in the vehicle seat device 10 indicates the direction along the width direction of the vehicle when the vehicle seat device 10 is located in the reference position. A vehicle front-to-rear direction DY in the vehicle seat device 10 indicates the direction along the front-to-rear direction of the vehicle when the vehicle seat device 10 is located in the reference position. A vertical direction DZ in the vehicle seat device 10 indicates the direction along the vertical direction of the vehicle when the vehicle seat device 10 is located in the reference position.

As shown in FIG. 1, a seat 1 includes a seat cushion 1a and a seatback 1b. The seatback 1b is rotationally attached to the seat cushion 1a. The seat cushion 1a includes two cushion frames 2 arranged respectively on the opposite sides in the vehicle width direction DX. The two cushion frames 2 are coupled to each other by two rods (not shown) that are spaced apart from each other in the vehicle front-to-rear direction DY.

The seat 1 is fixed to the vehicle seat device 10. Movement of the vehicle seat device 10 lifts and lowers the seat 1. The vehicle seat device 10 is fixed to the vehicle floor or a seat-mounting device, which fixed to the vehicle floor. The seat-mounting device includes a seat-sliding device. The seat-sliding device changes the position of the seat 1 fixed to the vehicle floor in the vehicle front-to-rear direction DY. The seat-sliding device may include a seat-rotating device. The seat-rotating device rotates the seat 1 about the line extending along the vertical direction DZ.

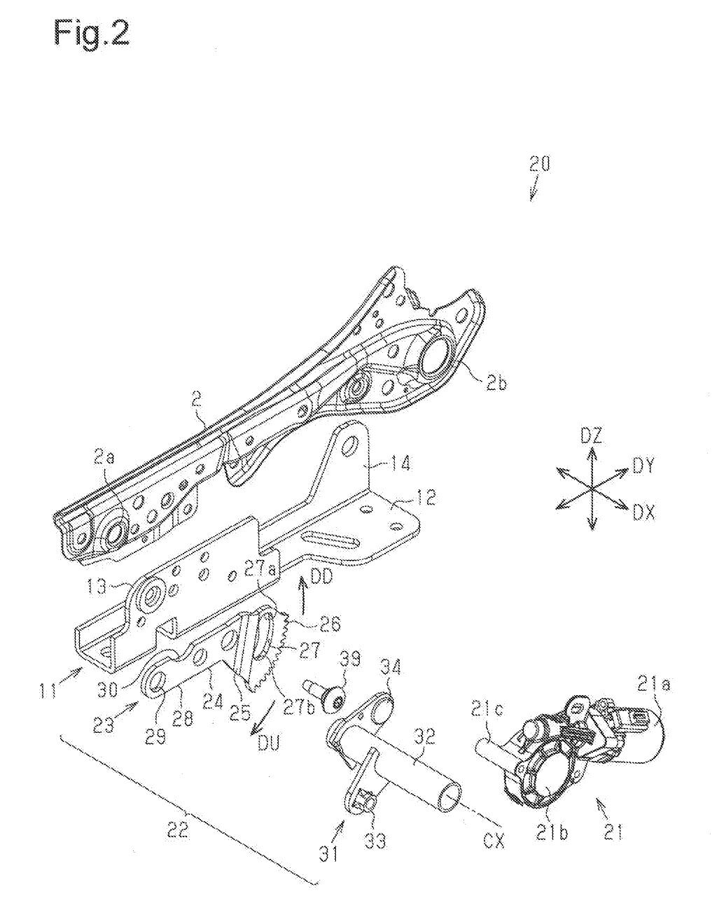

The vehicle seat device 10 will now be described with reference to FIG. 2.

The vehicle seat device 10 includes a base 11 and a front lift mechanism 20. The front lift mechanism 20 supports the front of the seat cushion 1a. The vehicle seat device 10 may further include a rear lift mechanism 40 in addition to the base 11 and the front lift mechanism 20. The rear lift mechanism 40 supports the rear of the seat cushion 1a. In the following description, the vehicle seat device 10 including the rear lift mechanism 40 will be described.

The base 11 is attached to the vehicle floor or the seat-mounting device (for example, seat-sliding device). The base 11 includes a fixed portion 12, a first attached portion 13, and a second attached portion 14. The fixed portion 12 is fixed to the vehicle floor or the seat-mounting device. The first attached portion 13 extends upward at the front of the fixed portion 12. The second attached portion 14 extends upward at the rear of the fixed portion 12.

The front lift mechanism 20 is arranged between the first attached portion 13 and the front of the cushion frame 2 and connects the first attached portion 13 to the cushion frame 2. The front lift mechanism 20 vertically moves the front of the seat cushion 1a. The rear lift mechanism 40 is arranged between the second attached portion 14 and the rear of the cushion frame 2 and connects the second attached portion 14 to the cushion frames 2. The rear lift mechanism 40 vertically moves the entire seat cushion 1a.

The front lift mechanism 20 is provided in one side of the seat 1 in the vehicle width direction DX. The other side of the seat 1 in the vehicle width direction DX is supported by a link (not shown) having the same structure as the link mechanism of the front lift mechanism 20. That is, the link supporting the other side includes a lever corresponding to a driven gear 23 (described later) and a coupling link corresponding to a coupling link 31 (described later).

The front lift mechanism 20 will now be described with reference to FIG. 2.

The front lift mechanism 20 includes a first lifter link 22 and a first drive device 21. The first drive device 21 moves the first lifter link 22. The first drive device 21 is attached to the base 11. The first lifter link 22 is driven based on the movement of the first drive device 21 to move the front of the seat cushion 1a vertically relative to the base 11.

The first drive device 21 includes a motor 21a and a reduction mechanism 21b. The reduction mechanism 21b reduces the speed of the output of the motor 21a. The first drive device 21 is provided with an engaging portion 21c. The engaging portion 21c defines a rotation angle range of the driven gear 23 (described later). For example, the engaging portion 21c projects from the reduction mechanism 21b of the first drive device 21 toward the driven gear 23. The engaging portion 21c engages with an engaged portion 27 of the driven gear 23. The engaging portion 21c may be provided on the base 11.

The first lifter link 22 couples the first attached portion 13 of the base 11 to the front end of the cushion frame 2. The first lifter link 22 includes the driven gear 23 and the coupling link 31.

The driven gear 23 is rotationally supported by the base 11 and rotated by the first drive device 21. The driven gear 23 includes a rotation center 24, a first arm 25, and a second arm 28. The first arm 25 extends rearward from the rotation center 24. The second arm 28 extends frontward from the rotation center 24. The rotation center 24 is attached to the first attached portion 13 of the base 11 by a rotation shaft 39. The driven gear 23 is supported with respect to the base 11 to be rotational about the rotation shaft 39.

The rear end of the first arm 25 is provided with a gear 26. The gear 26 includes a plurality of teeth extending rearward. The teeth of the gear 26 are laid out along an arc around the rotation center of the rotation shaft 39. The gear 26 meshes with the output gear of the reduction mechanism 21b of the first drive device 21. The driven gear 23 rotates based on rotational motion applied to the gear 26. Downward movement of the gear 26 rotates the driven gear 23 in a tilt-up rotation direction DU. The tilt-up rotation direction DU is a direction in which a coupled portion 29 of the second arm 28 is lifted. Upward movement of the gear 26 rotates the driven gear 23 in a tilt-down rotation direction DD. The tilt-down rotation direction DD is a direction in which the coupled portion 29 of the second arm 28 is lowered.

The first arm 25 is provided with the engaged portion 27. The engaged portion 27 extends along the layout direction of the teeth of the gear 26. The engaged portion 27 engages with the engaging portion 21c to limit the rotation angle of the driven gear 23.

The engaged portion 27 includes a first part 27a and a second part 27b. For example, the engaged portion 27 is configured as a through hole in which the first part 27a and the second part 27b are provided on the hole surface. When the driven gear 23 rotates in the tilt-up rotation direction DU, the first part 27a engages with the engaging portion 21c to limit the rotation of the driven gear 23 in the tilt-up rotation direction DU. When the driven gear 23 rotates in the tilt-down rotation direction DD, the second part 27b engages with the engaging portion 21c to limit the rotation of the driven gear 23 in the tilt-down rotation direction DD.

The front end of the second arm 28 is provided with the coupled portion 29. The first coupling portion 33 of the coupling link 31 is rotationally coupled to the coupled portion 29. The coupled portion 29 is configured as, for example, a circular hole. The coupling link 31 rotates with respect to the driven gear 23 about the center of the coupled portion 29 of the second arm 28.

The upper surface of the second arm 28 is provided with an abutment portion 30. The abutment portion 30 abuts a coupling rod 32 (described later) of the coupling link 31. The abutment portion 30 is located between the coupled portion 29 of the second arm 28 and the rotation center 24. When the coupling link 31 rotates in a direction approaching the driven gear 23 (hereinafter referred to as a folding rotation direction DF, refer to FIG. 1), the coupling rod 32 of the coupling link 31 abuts the abutment portion 30 of the second arm 28 to stop the coupling link 31 from rotating. That is, the abutment portion 30 limits the rotation in the folding rotation direction DF.

The coupling link 31 couples the front end of the second arm 28 of the driven gear 23 to the front end of the cushion frame 2.

The coupling link 31 includes the coupling rod 32, the first coupling portion 33, and a second coupling portion 34. The coupling rod 32 extends in the vehicle width direction DX. The first coupling portion 33 extends perpendicular to the rotation center line CX of the coupling rod 32. The second coupling portion 34 extends perpendicular to the rotation center line CX in a direction different from that of the first coupling portion 33. The first coupling portion 33 and the second coupling portion 34 are spaced apart from each other along the rotation center line CX on the direction of the coupling rod 32. As described above, the first coupling portion 33 is rotationally coupled to the coupled portion 29, which is provided on the front end of the driven gear 23. The second coupling portion 34 is rotationally coupled to the coupled portion 2a, which is provided on the front of the cushion frame 2.

The rear lift mechanism 40 will now be described with reference to FIG. 1.

The rear lift mechanism 40 includes a second lifter link 42 and a second drive device 41. The second drive device 41 moves the second lifter link 42. The second lifter link 42 is driven based on the movement of the second drive device 41 to move the entire seat cushion 1a vertically relative to the base 11.

The second lifter link 42 couples the second attached portion 14 of the base 11 to the rear end of the cushion frame 2. The second lifter link 42 includes a first end 42a rotationally coupled to the second attached portion 14 of the base 11. The second lifter link 42 includes a second end 42b rotationally coupled to the coupled portion 2b, which is provided in the rear of the cushion frame 2, directly or via a coupling component. The second lifter link 42, the cushion frame 2, and the first lifter link 22 constitute a four-bar link mechanism.

The second lifter link 42 rotates to move the second end 42b rearward and downward along an arc about a part coupled to the second attached portion 14. As a result, the seat cushion 1a is lowered. This rotation direction is hereinafter referred to as a lowering rotation direction DE. Further, the second lifter link 42 rotates to move the second end 42b frontward and upward along the arc about the part coupled to the second attached portion 14. As a result, the seat cushion 1a is lifted. This rotation direction is hereinafter referred to as a lifting rotation direction DV. The angle between the second lifter link 42 and the cushion frame 2 is defined by the movement of the second drive device 41.

The operation of the vehicle seat device 10 will now be described.

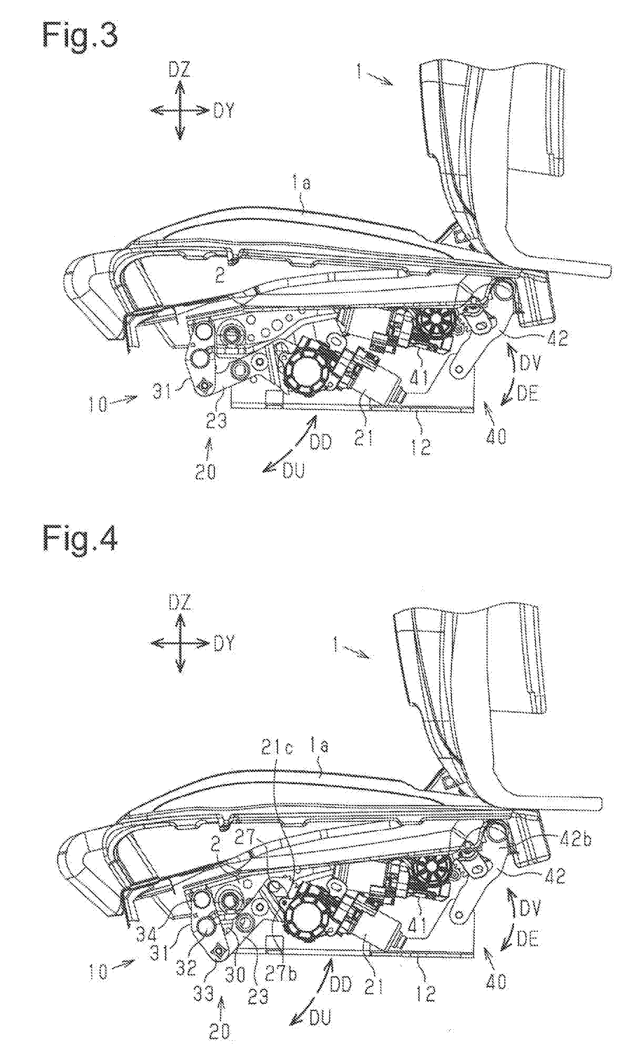

First, a tilt-down movement of the seat 1 from the reference position of the seat 1 shown in FIG. 1 will be described with reference to FIGS. 1, 3, and 4. FIG. 1 shows the seat 1 located at the uppermost position (hereinafter referred to as the highest position). FIGS. 3 and 4 show that the front of the seat 1 moves downward.

As shown in FIG. 1, when the seat 1 is located at the highest position, the driven gear 23 of the front lift mechanism 20 rotates to the maximum angle in the tilt-up rotation direction DU. The second lifter link 42 of the rear lift mechanism 40 rotates to the maximum angle in the lifting rotation direction DV.

In the lowering movement of the seat 1, in a state in which the second drive device 41 of the rear lift mechanism 40 does not move, the first drive device 21 of the front lift mechanism 20 moves (hereinafter referred to as first movement). The first movement of the first drive device 21 rotates the driven gear 23 in the tilt-down rotation direction DD. This lowers the second arm 28 of the driven gear 23. As a result, the front of the seat cushion 1a is lowered (refer to FIG. 3). Further, as shown in FIG. 4, when the driven gear 23 rotates to the maximum angle in the tilt-down rotation direction DD, the seat 1 is inclined frontward. The engaging portion 21c of the first drive device 21 abuts the second part 27b of the engaged portion 27 of the driven gear 23 or is located at the position proximate to the second part 27b. This prevents the front of the seat 1 from further being lowered (refer to FIG. 4).

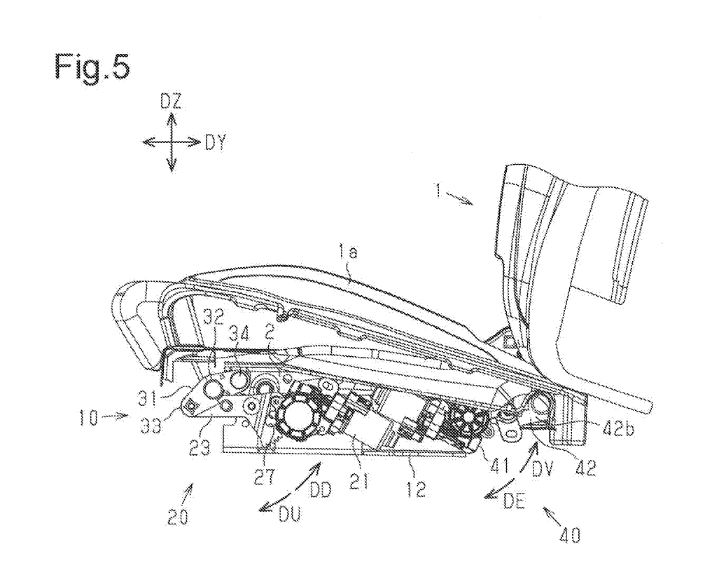

Movement of the second drive device 41 of the rear lift mechanism 40 in a state in which the first drive device 21 does not move from the reference position of the seat 1 as shown in FIG. 1 (hereinafter referred to as second movement) will now be described with reference to FIGS. 1 and 5. FIG. 5 shows the seat 1 located at the lowermost position (hereinafter referred to as the lowest position).

When the second movement of the rear lift mechanism 40 rotates the second lifter link 42 in the lowering rotation direction DE (refer to FIG. 1), the second end 42b of the second lifter ink 42 is lowered diagonally rearward and the rear of the seat 1 is lowered. This moves the coupling link 31 of the front lift mechanism 20 in the folding rotation direction DF. As a result, the coupling rod 32 is located in the proximity of the abutment portion 30 of the driven gear 23 or is in contact with the abutment portion 30. In this manner, the seat 1 is lowered from the highest position to the lowest position. When the four-bar link mechanism lowers the entire seat cushion 1a, the abutment portion 30 of the driven gear 23 prevents the coupling rod 32 from moving downward, and the rotation of the coupling link 31 in the folding rotation direction DF is limited. This limits the movement of the entire seat cushion 1a.

As described above, the seat 1 is inclined frontward by the first movement and stably lowered by the second movement. The seat 1 is returned from the frontward-inclined position to the reference position by the movement opposite to the first movement and stably lifted by the movement opposite to the second movement.

The advantages of the vehicle seat device 10 of the present embodiment will now be described.

(1) The vehicle seat device 10 includes the base 11, the first lifter link 22 (lifter link), and the first drive device 21. The first lifter link 22 moves the seat cushion 1a vertically relative to the base 11. The first drive device 21 moves the first lifter link 22 relative to the base 11. The first lifter link 22 includes a plurality of members. In the embodiment, the driven gear 23 and the coupling link 31 correspond to the “plurality of members.” The first drive device 21 is directly or indirectly coupled to the first lifter link 22. The first drive device 21 is attached to the base 11. The first drive device 21 may be attached to any one of the base 11, the vehicle floor, or the seat-mounting device.

With the conventional structure, the first drive device 21 is attached to the cushion frame 2. Tubs, the first drive device 21 lifts and lowers the first drive device 21 itself as well as the seat 1. In contrast, with the above-illustrated structure, the first drive device 21 does not lift and lower the first drive device 21 itself. Thus, as compared to the conventional vehicle seat device, the energy consumed to lift and lower the seat 1 is reduced. That is, the above vehicle seat device 10 is driven with less power consumption.

(2) The first lifter link 22 includes the driven gear 23 and the coupling link 31. The coupling link 31 couples the driven gear 23 to the seat cushion 1a and is rotationally attached to the driven gear 23 and the seat cushion 1a. This simplifies the structure of the first lifter link 22.

(3) The rotation angle range of the driven gear 23 is defined by engagement of the driven gear 23 with the engaging portion 21c, which is provided on the base 11 or the first drive device 21. This structure allows the driven gear 23 to be rotated in the rotation angle range. Thus, excessive inclination of the seat cushion 1a is prevented.

(4) The driven gear 23 includes the abutment portion 30. When the coupling link 31 rotates with respect to the driven gear 23, the abutment portion 30 abuts the coupling link 31. This structure limits the rotation angle of the coupling link 31 with respect to the driven gear 23.

The abutment portion 30 may be provided between the rotation center 24 and the coupled portion 29 in the driven gear 23. This structure causes load applied to the coupling link 31 to be applied to the abutment portion 30. The abutment portion 30 is located closer to the rotation center 24 than to the coupled portion 29. Thus, as compared to when such abutment does not occur, the load applied to the coupling link 31 is efficiently distributed to the base 11 through the rotation shaft 39. Thus, since the load applied to the coupling link 31 is reduced, the coupling link 31 deforms in a limited manner.

(5) The vehicle seat device 10 includes the first lifter link 22, the second lifter link 42, the first drive device 21, and the second drive device 41. The first lifter link 22 includes a single joint. The second lifter link 42 does not include a joint. The second lifter link 42 couples the base 11 to the seat cushion 1a and is rotationally attached to the base 11 and the seat cushion 1a. In the present embodiment, the first lifter link 22 supports the front of the seat cushion 1a. The second lifter link 42 supports the rear of the seat cushion 1a. As described in Other Embodiments below, the first lifter link 22 may support the rear of the seat cushion 1a and the second lifter link 42 may support the front of the seat cushion 1a.

With this structure, one of the front and the rear of the seat cushion 1a is supported by a link having a single joint, and the other one of the front and the rear of the seat cushion 1a is supported by a link that does not have a joint. Thus, as compared to the structure in which the front and the rear of the seat cushion 1a are supported by a link having a joint, the seat cushion 1a is easily lifted and lowered in a stable manner. Additionally, the seat 1 can be partially lifted and lowered without impairing the normal lifter operation. (Lifting and lowering of the entire seat 1). In this embodiment, the joint of the first lifter link 22 is a part where the driven gear 23 is coupled to the coupling link 31.

(6) The vehicle seat device 10 includes the first Lifter pink 22, which has a single joint, and the second lifter link 42, which does not have a joint.

The vehicle seat device 10 has, as movement for lowering the seat 1, the first movement and the second movement as follows. The first movement (frontward-inclining movement) rotates the driven gear 23 of the first lifter link 22 in the tilt-down rotation direction DD. This structure allows the seat 1 to be smoothly inclined frontward. The second movement (lowering movement) rotates the second lifter link 42 in the lowering rotation direction DE. This structure allows the entire seat 1 to be smoothly lowered.

The vehicle seat device 10 has, as movement for lifting the seat 1, third movement and fourth movement as follows. The third movement rotates the second lifter link 42 in the lifting rotation direction DV. This structure allows the entire seat 1 to be smoothly lifted. The fourth movement rotates the driven gear 23 of the first lifter link 22 in the tilt-up rotation direction DU. This structure smoothly returns the frontward-inclined position of the seat 1 to the reference position.

### Other Embodiments

The vehicle seat device 10 is not limited to the above embodiment. Other embodiments include the following examples.

In the above-described embodiment, rotation of the driven gear 23 is limited by engagement with the engaging portion 21c. Instead, rotation of the driven gear 23 may be limited by the following structures. Three examples will now be described. In a first example, the rotation angle of the output shaft of the motor 21a is limited based on drive control of the motor 21a. This limits the rotation angle of the driven gear 23. In a second example, the first drive device 21 is provided with a rotation limitation mechanism that limits rotation of a rotating member in the first drive device 21. This limits the rotation angle of the driven gear 23. In a third example, in gear meshing in the power transmission path from the output shaft of the motor 21a of the first drive device 21 to the driven gear 23, a range in which gears mesh and a range in which the gears do not mesh are defined. This cuts off the transmission of rotational power at a predetermined rotation angle. Such a structure also limits the rotation angle of the driven gear 23. Any mechanisms of the three examples are applicable to the second lifter link 42.

In the above-described embodiment, the engaging portion 21c defining the rotation of the driven gear 23 projects toward the driven gear 23. Instead, the engaging portion 21c may be configured as a recess. In this case, the engaged portion 27 of the driven gear 23 is configured as a projection inserted into the recessed engaging portion 21c.

In the above-described embodiment, the first lifter link 22 supports the front of the seat cushion 1a, and the second lifter link 42 supports the rear of the seat cushion 1a. Instead, in the vehicle seat device 10, the second lifter link 42 may support the front of the seat cushion 1a, and the first lifter link 22 may support the rear of the seat cushion 1a.

Therefore, the present examples and embodiments are to be considered as illustrative and not restrictive and the invention is not to be limited to the details given herein, but may be modified within the scope and equivalence of the appended claims.

1. A vehicle seat device that lifts and lowers a seat, the vehicle seat device, comprising:
a base;
a lifter link comprising a plurality of members that move a seat cushion of the seat vertically relative to the base; and
a drive device coupled to the lifter link, wherein:
the drive device relatively moves the lifter link; and
the drive device is attached to the base, a vehicle floor, or a seat-mounting device fixed to the vehicle floor.

2. The vehicle seat device according to claim 1, wherein the lifter link comprises:
a driven gear rotationally supported by the base, wherein the driven gear is rotated by the drive device; and
a coupling link coupling the driven gear to the seat cushion, wherein the coupling link is rotationally attached to the driven gear and the seat cushion.

3. The vehicle seat device according to claim 2, wherein a rotation angle range of the driven gear is defined by engagement of the driven gear with an engaging portion provided on the base or the drive device.

4. The vehicle seat device according to claim 2, wherein the driven gear includes an abutment portion that abuts the coupling link when the coupling link rotates with respect to the driven gear.

5. The vehicle seat device according to claim 1, wherein the lifter link is a first lifter link, and the vehicle seat device further comprises:
a second lifter link that is different from the first lifter link; and
a second drive device that moves the second lifter link, wherein
the second lifter link couples the base to the seat cushion,
the second Lifter link is rotationally attached to the base and the seat cushion,
the first lifter link supports one of a front and a rear of the seat cushion, and
the second lifter link supports the other one of the front and the rear of the seat cushion.
